(19) United States
(12) Patent Application Publication
(10) Pub. No.: US 2006/0158754 A1
(43) Pub. Date: Jul. 20, 2006

(54) Space optical modulator

(75) Inventors: Takuya Tsukagoshi, Kanagawa (JP); Jiro Yoshinari, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/562,929

(22) PCT Filed: Jun. 3, 2004
(86) PCT No.: PCT/JP04/07694

§ 371 Date: Dec. 30, 2005

(30) Foreign Application Priority Data
Jul. 15, 2003 (JP) 2003-197081

(51) Int. Cl. G02B 5/08

(52) U.S. Cl. 359/851

(57) ABSTRACT

A spatial light modulator that can quickly switch the focal length and light intensity distribution. This spatial light modulator 10 has a plurality of micro mirrors 14A, 14B, 14C, - - - arranged on a substrate 12 and these micro mirrors 14A, 14B, 14C - - - are each provided with a reflection angle distribution such that they converge the reflected light at one point for one reflection angle state with respect to incident collimated light and such that the reflected light is diverged for the other reflection angle state.

### TECHNICAL FIELD

The present invention relates to a spatial light modulator that uses a micro mirror array to allow a variable focal point or adjust the light intensity distribution.

### BACKGROUND ART

From the past many different variable focal point optical elements with a function to adjust the focal lengths in the optical elements themselves have been proposed.

From among these types of variable focal point optical elements, there is a variable focal point mirror that provides a film thickness distribution to a silicone diaphragm and forms a paraboloid shaped concave mirror with a variable focal length.

In addition, conventionally it was necessary to uniformly modulate the light intensity distribution for incident light with a Gaussian light intensity distribution.

Because the variable focal point mirror mentioned above uses a silicone diaphragm, there are problems of time being required to switch the focal length and poor responsiveness.

There are also problems of the need to use a lens that has a special refractive index distribution in order to uniformly modulate the light intensity distribution for incident light of a Gaussian light intensity distribution, thereby increasing costs.

### DISCLOSURE OF THE INVENTION

The present invention takes the conventional problems mentioned above into consideration and has an object of providing a spatial light modulator that can quickly change the focal position.

Another object of the present invention is to provide spatial light modulator that can modulate light intensity distribution without using any lens.

From the results of diligent research, the inventor discovered that it was possible to quickly change the focal position by providing a reflection angle distribution for a micro mirror in a spatial light modulator known as a DMD (Digital Micro mirror Device: trademark), thereby obtaining a uniform light intensity distribution.

In summary, the above-described objectives are achieved by the following aspects of the present invention.

(1) A spatial light modulator wherein a plurality of micro mirrors are arranged in an array configuration on a substrate and an inclination of a reflecting surface of each micro mirror can be independently controlled to one of two reflection angle states by an electrostatic attracting force exerted between the substrate, the spatial light modulator being characterized by providing a reflection angle distribution to each micro mirror such that collimated light incident on the micro mirrors is reflected to be converged at one point for one of the reflection angle states.

(2) A spatial light modulator wherein a plurality of micro mirrors are arranged in an array configuration on a substrate and an inclination of a reflecting surface of each micro mirror can be independently controlled to one of two reflection angle states by an electrostatic attracting force exerted between the substrate, the spatial light modulator being characterized by providing a reflectance distribution to the micro mirror array.

(3) The spatial light modulator according to (2) wherein the reflectance distribution is set to an almost inverse proportion to a Gaussian distribution such that incident light with a Gaussian distribution light intensity is formed into reflected light with a uniform light intensity distribution for one of the two reflection angle states.

(4) The spatial light modulator according to (2) or (3) wherein the reflectance distribution is provided by adjusting a film thickness of a reflectivity modulation film provided on a surface of the micro mirror for each micro mirror.

(5) The spatial light modulator according to any one of (1) to (4) wherein a surface on which the micro mirrors are arrayed is a concave or convex curved surface.

(6) The spatial light modulator according to (2) or (3) wherein the reflectance distribution is provided by arranging a mask plate, whereon micro apertures are formed at the same quantity and same pitch as the micro mirrors, on a front surface of the micro mirror array, the micro apertures having an area smaller than the micro mirrors, inclining the micro mirrors to a parallel surface of the mask plate in at least one of the reflection angle states thereof, and adjusting an inclination angle for each micro mirror.

(7) The spatial light modulator according to (2) or (3) wherein: the micro mirror array is provided with a non-reflective region on a periphery of each of the micro mirrors; a mask plate is arranged on a front surface of the micro mirror array, the mask plate having micro apertures at the same pitch as the micro mirrors; and the mask plate can change its position so as to change an overlapping area of the micro apertures with respect to the micro mirrors, thereby substantially providing a reflectance distribution for the micro mirrors.

(8) The spatial light modulator according to (7) wherein the mask plate is arranged parallel to the surface of the micro mirror array and also is able to freely rotate by any angle around an axis perpendicular to the surface.

(9) The spatial light modulator according to (6), (7), or (8) wherein the mask plate is able to freely adjust the rotation angle around an axis parallel to the surface of the micro mirror array.

### BRIEF DESCRIPTION OF THE DRAWINGS

FIG. 1 is an enlarged cross-sectional view showing the main components of a micro mirror array spatial light modulator according to example 1 of one exemplary embodiment of the present invention;

FIG. 2 is a perspective view showing the micro mirror array spatial light modulator according to example 2 of the same exemplary embodiment;

FIG. 3 is a schematic enlarged cross-sectional view of the main components;

FIG. 4 is a diagrammatic view showing the relationship between the thickness of a thin Au film, that functions as a reflectivity modulation film, and the optical characteristics of that Au film;

FIG. 5 is a diagrammatic view showing the relationship between the thickness distribution of a thin Au film when the intensity distribution of reflected light is made uniform and the intensity distribution of incident light and reflected light;

FIG. 6 is a schematic enlarged view showing an example of the composition of a micro mirror equipped with a reflective film on the mirror substrate;

FIG. 7 is a diagrammatic view showing the relationship between the film thickness of a thin Al film that functions as a reflective film, and the optical characteristics of that Al film;

FIG. 8 is a diagrammatic view showing the relationship between the thickness distribution of a thin Al film when the intensity distribution of reflected light is made uniform and the intensity distribution of incident light and reflected light;

FIG. 9 is a schematic enlarged view showing an optical absorption layer existing between the reflective film and the mirror substrate;

FIG. 10 is an enlarged perspective view showing the main components of the micro mirror array spatial light modulator according to example 3 of the exemplary embodiment of the present invention;

FIG. 11 is an enlarged perspective view showing the main components of the micro mirror array spatial light modulator according to example 4 of the exemplary embodiment of the present invention;

FIG. 12 is an enlarged perspective view showing the relationship between the micro mirror and the micro aperture in example 4; and

FIG. 13 is an enlarged perspective view showing the main components of the micro mirror array spatial light modulator according to example 5 of the exemplary embodiment of the present invention.

### BEST MODE FOR CARRYING OUT THE INVENTION

In the following, exemplary embodiments of the present invention will be described in detail.

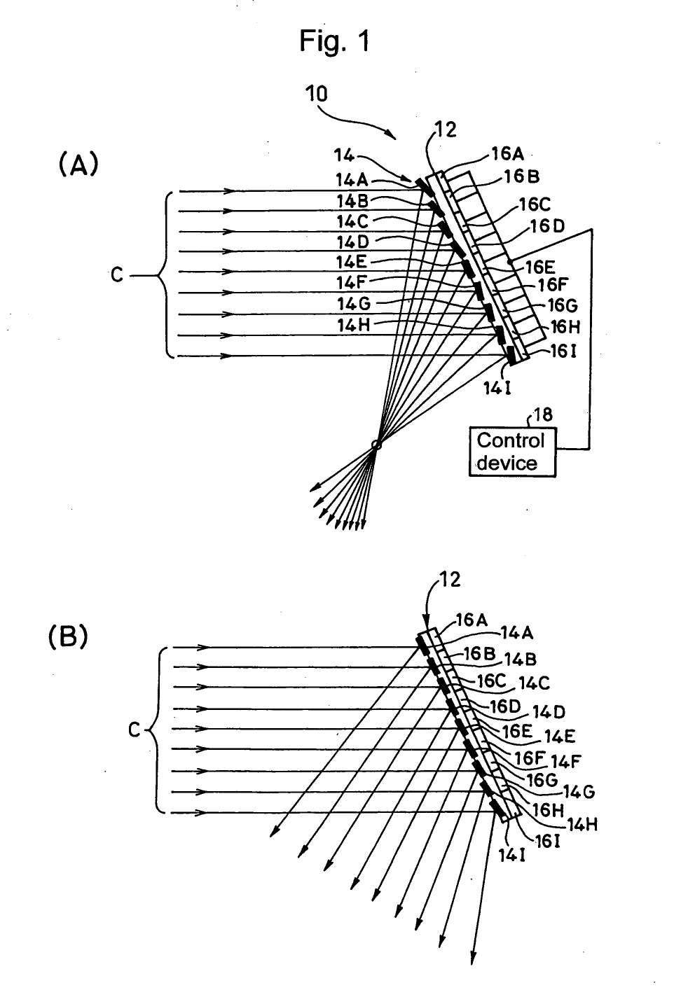

As shown in FIGS. 1 (A) and (B), the spatial light modulator 10 (hereinafter referred to as SLM) according to example 1 of the exemplary embodiment of the present invention is a device that is configured by arranging a plurality of micro mirrors 14A, 14B, 14C, - - - , 14I on a substrate 12 in an array configuration corresponding to memory cells 16A, 16B, 16C, - - - , 16I and that selectively changes between one of two reflection angle states of each of the micro mirrors 14A, 14B, 14C, - - - by applying or releasing an electrostatic attracting force exerted between the memory cells 16A, 16B, 16C, - - - . As shown in FIG. 1 (A), for one of the two reflection angle states mentioned above a micro mirror array 14, composed of the micro mirrors 14A, 14B, 14C, - - - , is provided with a reflection angle distribution to reflect incident collimated light C to be converged at one point and as shown in FIG. 1 (B) for the other reflection angle state mentioned above, the micro mirror array 14 is provided with a reflection angle distribution to reflect incident collimated light C to be diverged.

The reference numeral 18 in FIG. 1 is a control device. This device simultaneously controls the micro mirrors 14A, 14B, 14C, - - - through each of the memory cells 16A, 16B, 16C, - - - so as to change between the two reflection angle states mentioned above.

This SLM 10 can quickly switch the state of the micro mirrors 14A, 14B, 14C, - - - from one of the reflection angle states to the other using the control device 18.

The reflection angle distribution of the micro mirrors 14A, 14B, 14C, - - - is formed by composing the substrate 12 using a flexible material to form the micro mirror array 14 and then curving the surface thereof into a concave spheric shape, for example.

If the present invention can converge reflected light at one point in one of the reflection angle states mentioned above, the other reflection angle state is not limited to forming a divergent reflected light.

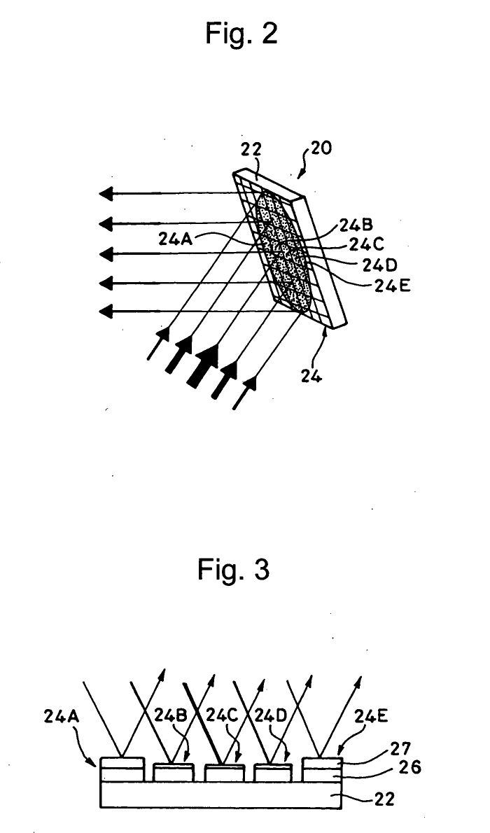

Next, an SLM 20 according to example 2 of the exemplary embodiment of the present invention shown in FIG. 2 will be described.

This SLM 20 provides a reflectance distribution to each micro mirror 24A, 24B, 24C, 24D, 24E, - - - which constitute a micro mirror array 24.

As shown in FIG. 3, the micro mirrors 24A, 24B, - - - are normally composed of an Al layer 26 and form a reflectance distribution by providing a material, such as a thin Au film 27 that modulates the reflectance corresponding to the film thickness, on the surface of this Al layer 26 and providing a film thickness distribution to this thin Au film 27.

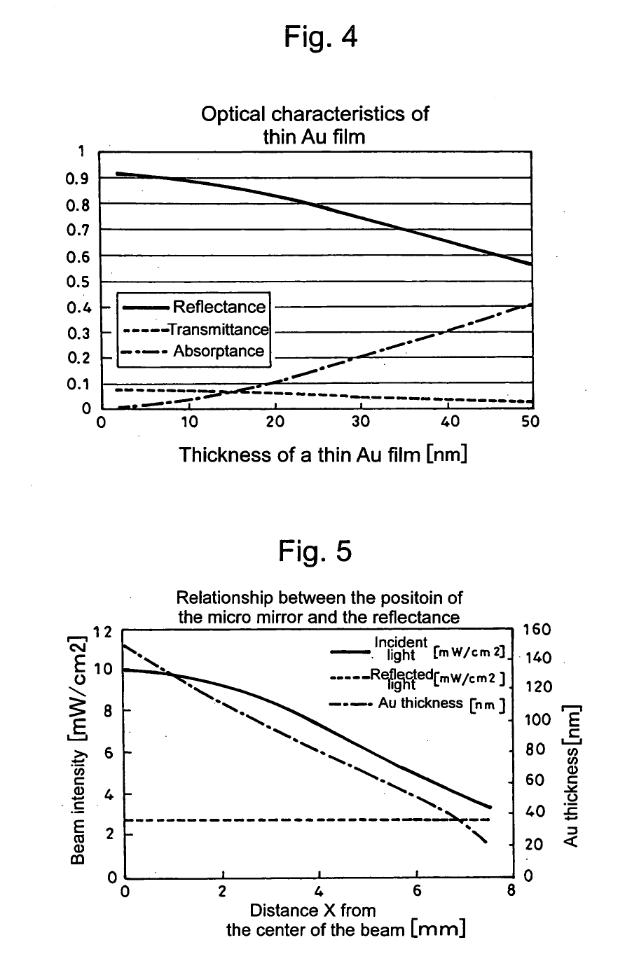

If the Al layer 26 is sufficiently thick when the thin Au film 27 is used, the relationship between the film thickness and the optical characteristics (reflectance, transmittance, absorptance) is as shown in FIG. 4 and a reflectance distribution of the micro mirrors 24A, 24B, - - - can be formed by the film thickness distribution of the thin Au film 27. For this case, the reflectance of the Al layer 26 reduces as the thin Au film 27 becomes thicker.

For example, in order to form incident light (refer to solid line of FIG. 5) with a Gaussian light intensity distribution (20 mm beam diameter with an intensity of 1/e²) into reflected light with a uniform light intensity distribution, the thin Au film 27 is made thinner to provide a reflectance distribution as the position of the micro mirror separates from the center of the incident light beam as shown by the dash-dot line in FIG. 5. This makes the intensity distribution of the reflected light uniform as shown by the broken line in FIG. 5.

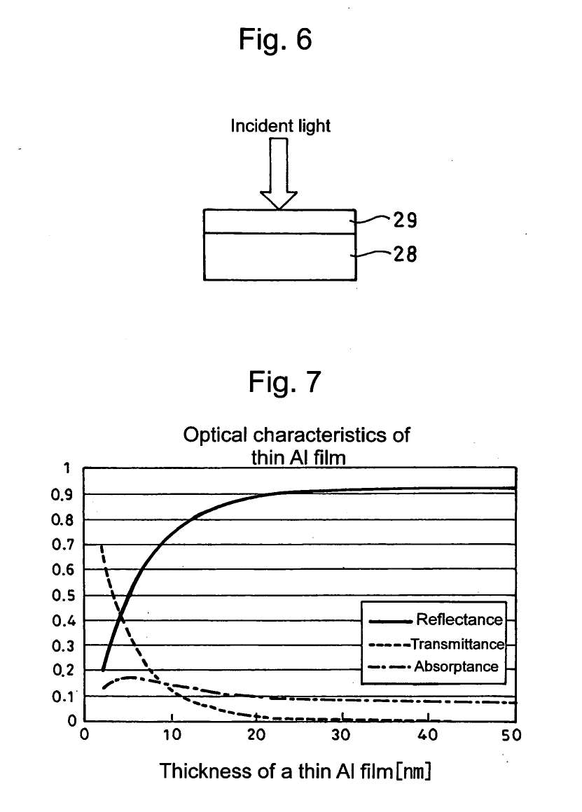

As shown in FIG. 6, the reflectance distribution of the micro mirror can also be formed using the film thickness distribution of the thin Al film 29 formed on a mirror substrate 28 composed of glass (Bk7) for example.

For this case, when the film thickness of the thin Al film 29 is considerable, the reflectance thereof becomes larger and a reflectance distribution is formed. The relationship between the thickness of the thin Al film 29 and the optical characteristics (reflectance, transmittance, absorptance) is as shown in FIG. 7.

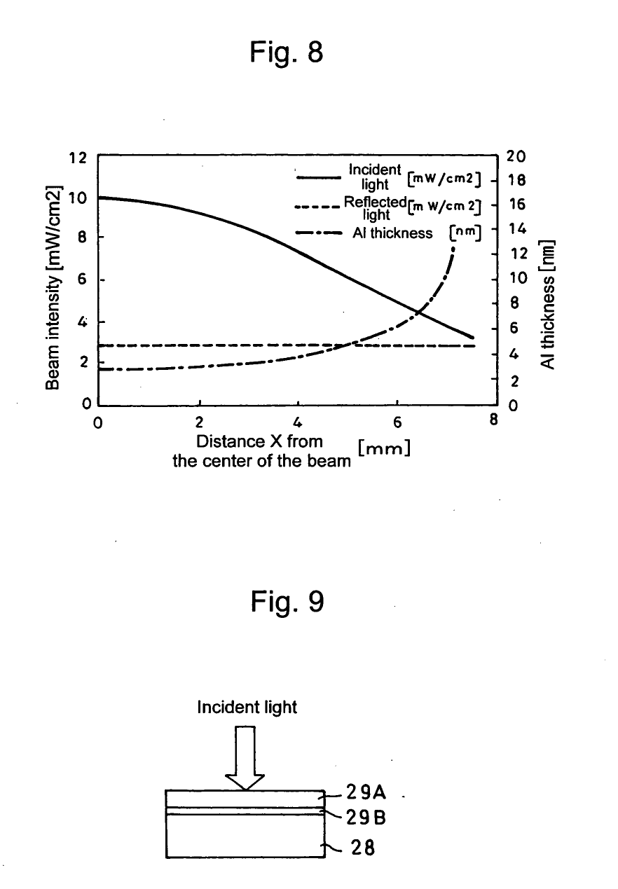

As shown in FIG. 8, for the incident light (solid line) with a Gaussian light intensity distribution (20 mm beam diameter with an intensity of 1/e²), reflected light with a uniform light intensity distribution is obtained as shown by the broken line when the thickness of the thin Al film 29 as shown by the dash-dot line is made thicker as the position of the micro mirror separates from the center of the incident light beam in contrast to FIG. 5.

Furthermore, if the reflectance of the surface of the mirror substrate 28 is high when forming a reflectance distribution using the thickness of a thin metal film that constitutes a mirror surface as shown in FIG. 6 and FIG. 8, the desired reflectance distribution cannot be obtained due to that effect.

As an example for this case, an optical absorption layer 29B, composed of a mixture of phthalocyanine dye and a UV curable resin, can be formed between the thin metal film (including a thin Al film) 29A and the mirror substrate 28 as shown in FIG. 9. Examples of the material of the thin metal film include Ag, Pt, Cr, as well as Al.

The reflectance distribution of the micro mirrors 24A, 24B, - - - corresponds to the film thickness distribution of the thin Au film 27 or the thin metal film (including a thin Al film) 29. As an example, this film thickness distribution is formed as follows.

At first, a mask (dither mask) that has a pattern divided into small unit areas (for example, a square with 12 μm sides) is used and changes are made to the average transmittance of this unit area to allow half-tone exposures to produce a photomask that has an exposure distribution corresponding to the fabricated shape.

Then, using this photomask a desired film thickness distribution is obtained by normally exposing and etching the thin Au film 27, thickly formed on the Al layer 26 in advance, while modulating the etching depth for each micro mirror.

As described above, this film thickness distribution provides a reflectance distribution to the micro mirror array and this reflectance distribution makes the distribution of the light intensity uniform in the reflected light for ordinary incident light with a Gaussian light intensity distribution.

The thin Au film and thin Al film are not limited to this and a reflectance modulation film that can modulate the reflectance using the film thickness can be used as well.

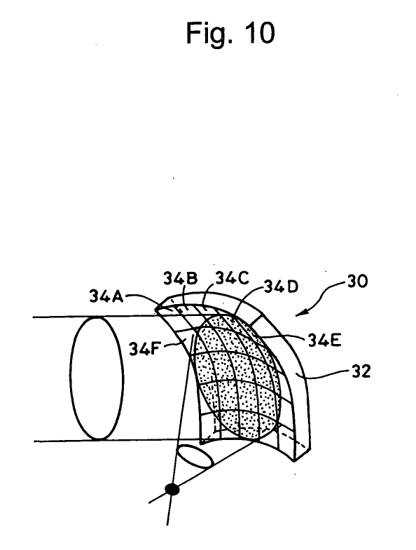

An SLM 30 according to example 3 of the exemplary embodiment of the present invention shown in FIG. 10 is configured by forming the micro mirrors 34A, 34B, 34C, - - - on a substrate 32 with a concave curved surface. The SLM 30 can also be configured by forming the micro mirrors 34A, 34B, 34C, - - - on a convex curved surface. These convex and concave curved surfaces can be formed by first forming the micro mirrors on a flexible substrate and then curving the substrate into a desired shape.

When collimated light is reflected and converged on a concave curved surface, the focal length can be made even shorter.

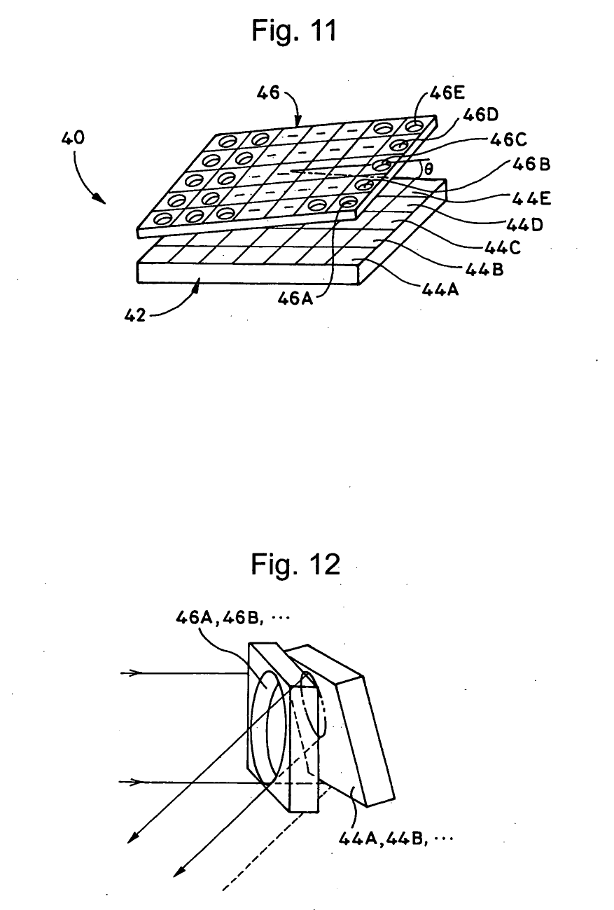

Next, an SLM 40 according to example 4 of the exemplary embodiment of the present invention shown in FIG. 11 will be described.

In this SLM 40 the reflectance distribution of the micro mirrors 44A, 44B, 44C - - - is provided by adjusting the reflecting area of each micro mirror.

In more detail, a mask plate 46, whereon micro apertures 46A, 46B, 46C, - - - are formed at the same quantity and same pitch as the micro mirrors 44A, 44B, 44C, - - - , is arranged on the front surface of the micro mirror array on the substrate 42. The mask plate 46 is arranged to freely adjust the rotation angle around the axis parallel to the above-mentioned front surface with respect to the surface of the micro mirror array. These micro apertures 46A, 46B, 46C, - - - have an area smaller than the micro mirrors 44A, 44B, 44C, - - - and the micro mirrors 44A, 44B, 44C, - - - are either parallel or inclined to the parallel surface of the mask plate 46 in one of reflection angle states thereof. A reflecting area distribution is provided by adjusting that angle for each micro mirror as described above.

As shown in FIG. 12, the relationship between the reflecting area and the reflectance distribution is one in such a manner that one part of the reflected light is blocked by the mask plate 46 when the incident light that passes through the micro apertures 46A, 46B, 46C, - - - is reflected by the back of the micro mirror 44 and thereby the beam diameter of the reflected light compared to the beam diameter of the incident light becomes smaller corresponding to the inclination angle.

Consequently, the reflectance distribution can be provided by adjusting the inclination angle of the mask plate 46 with respect to the micro apertures 44A, 44B, 44C, - - - .

Incidentally, although the inclination angle of the mask plate 46 with respect to the micro mirror array is fixed for the SLM 40 according to example 4 of the exemplary embodiment, the present invention is not limited to this and the inclination angle can be changed to obtain the reflecting area of each micro mirror or namely a substantial reflectance distribution.

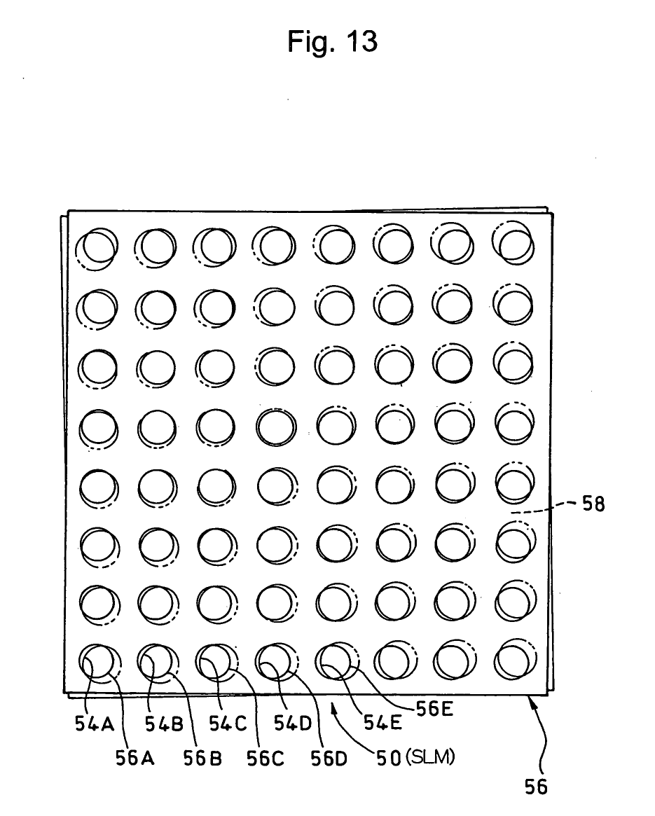

Next, an SLM 50 according to example 5 of the exemplary embodiment of the present invention will be described with reference to FIG. 13.

This SLM 50 obtains the reflectance distribution by providing a reflecting area distribution of the micro mirrors 54A, 54B, 54C, 54D, 54E, - - - in a like manner to example 4 of the exemplary embodiment.

As shown in FIG. 13, the micro mirrors 54A, 54B, 54C, - - - are configured such that a non-reflective region 58 is provided on the periphery of each of the micro mirrors and a mask plate 56 is arranged on the front surface of the micro mirror array. In the mask plate 56, micro apertures 56A, 56B, 56C, 56D, 56E, - - - , with areas smaller than the micro mirrors 54A, 54B, 54C, - - - on the inside of the non-reflective region, are formed at the same pitch as the micro mirrors 54A, 54B, 54C, - - - .

In order to change the overlapping area of the micro apertures 56A, 56B, 56C with respect to the micro mirror 54 when viewed from the front on the surface of the micro mirror array, the mask plate 56 can rotate around the central axis perpendicular to this surface. This can provide a reflecting area distribution of the micro mirrors 54A, 54B, 54C - - - .

### INDUSTRIAL APPLICABILITY

Because the present invention is configured as described above, there are excellent effects in an SLM that allows the focal position to be quickly changed or can change the light intensity distribution.

1. A spatial light modulator wherein a plurality of micro mirrors are arranged in an array configuration on a substrate and an inclination of a reflecting surface of each micro mirror can be independently controlled to one of two reflection angle states by an electrostatic attracting force exerted between the substrate,
the spatial light modulator being characterized by providing a reflection angle distribution to each micro mirror such that collimated light incident on the micro mirrors is reflected to be converged at one point for one of the reflection angle states.

2. A spatial light modulator wherein a plurality of micro mirrors are arranged in an array configuration on a substrate and an inclination of a reflecting surface of each micro mirror can be independently controlled to one of two reflection angle states by an electrostatic attracting force exerted between the substrate,
the spatial light modulator being characterized by providing a reflectance distribution to the micro mirror array.

3. The spatial light modulator according to claim 2 wherein the reflectance distribution is set to an almost inverse proportion to a Gaussian distribution such that incident light with a Gaussian distribution light intensity is formed into reflected light with a uniform light intensity distribution for one of the two reflection angle states.

4. The spatial light modulator according to claim 2 wherein the reflectance distribution is provided by adjusting a film thickness of a reflectivity modulation film provided on a surface of the micro mirror for each micro mirror.

5. The spatial light modulator according to claim 1 wherein a surface on which the micro mirrors are arrayed is a concave or convex curved surface.

6. The spatial light modulator according to claim 2 wherein the reflectance distribution is provided by arranging a mask plate, whereon micro apertures are formed at the same quantity and same pitch as the micro mirrors, on a front surface of the micro mirror array, the micro apertures having an area smaller than the micro mirrors, inclining the micro mirrors to a parallel surface of the mask plate in at least one of the reflection angle states thereof, and adjusting an inclination angle for each micro mirror.

7. The spatial light modulator according to claim 2 wherein: the micro mirror array is provided with a non-reflective region on a periphery of each of the micro mirrors; a mask plate is arranged on a front surface of the micro mirror array, the mask plate having micro apertures at the same pitch as the micro mirrors; and the mask plate can change its position so as to change an overlapping area of the micro apertures with respect to the micro mirrors, thereby substantially providing a reflectance distribution for the micro mirrors.

8. The spatial light modulator according to claim 7 wherein the mask plate is arranged parallel to the surface of the micro mirror array and also is able to freely rotate by any angle around an axis perpendicular to the surface.

9. The spatial light modulator according to claim 6, wherein the mask plate is able to freely adjust the rotation angle around an axis parallel to the surface of the micro mirror array.

10. The spatial light modulator according to claim 3 wherein the reflectance distribution is provided by adjusting a film thickness of a reflectivity modulation film provided on a surface of the micro mirror for each micro mirror.

11. The spatial light modulator according to claim 2 wherein a surface on which the micro mirrors are arrayed is a concave or convex curved surface.

12. The spatial light modulator according to claim 3 wherein a surface on which the micro mirrors are arrayed is a concave or convex curved surface.

13. The spatial light modulator according to claim 4 wherein a surface on which the micro mirrors are arrayed is a concave or convex curved surface.

14. The spatial light modulator according to claim 3 wherein the reflectance distribution is provided by arranging a mask plate, whereon micro apertures are formed at the same quantity and same pitch as the micro mirrors, on a front surface of the micro mirror array, the micro apertures having an area smaller than the micro mirrors, inclining the micro mirrors to a parallel surface of the mask plate in at least one of the reflection angle states thereof, and adjusting an inclination angle for each micro mirror.

15. The spatial light modulator according to claim 3 wherein: the micro mirror array is provided with a non-reflective region on a periphery of each of the micro mirrors; a mask plate is arranged on a front surface of the micro mirror array, the mask plate having micro apertures at the same pitch as the micro mirrors; and the mask plate can change its position so as to change an overlapping area of the micro apertures with respect to the micro mirrors, thereby substantially providing a reflectance distribution for the micro mirrors.

16. The spatial light modulator according to claim 7 wherein the mask plate is able to freely adjust the rotation angle around an axis parallel to the surface of the micro mirror array.

17. The spatial light modulator according to claim 8 wherein the mask plate is able to freely adjust the rotation angle around an axis parallel to the surface of the micro mirror array.
